(19) United States
(12) Patent Application Publication
(10) Pub. No.: US 2020/0380554 A1
(43) Pub. Date: Dec. 3, 2020

(54) ADVERTISING INFORMATION PROCESSING SYSTEM, ADVERTISING DISPLAY REGION EVALUATION METHOD, AND ADVERTISING INFORMATION PROCESSING PROGRAM

(71) Applicant: Alpha Code Inc., Tokyo (JP)

(72) Inventors: Takuhiro MIZUNO, Tokyo (JP); Yoshitaka NOMURA, Tokyo (JP)

(21) Appl. No.: 16/622,058

(22) PCT Filed: Apr. 2, 2018
(86) PCT No.: PCT/JP2018/014133

§ 371 Date: Dec. 12, 2019

(30) Foreign Application Priority Data
Jun. 14, 2017 (JP) 2017-116752

(51) Int. Cl. G06Q 30/02; G02B 27/00; G06F 3/0481

(52) U.S. Cl. CPC G06Q 30/0244; G06F 3/04815; G02B 27/0093; G06Q 30/0277

(57) ABSTRACT

An image playback unit 11 playing back a three-dimensional spatial image including a plurality of objects, an attention object detection unit 12 detecting an object that a viewer pays attention to from the three-dimensional spatial image that is played back, an attention degree calculation unit 13 calculating an attention degree of the viewer with respect to the object, and a region evaluation unit 14 evaluating a degree of effect of an advertising display region to be disposed in the vicinity of the object, in accordance with the calculated attention degree are provided. Since an advertising display region to be disposed in the vicinity of an object having a higher attention degree from the viewer is more likely to be seen from the viewer, a degree of effect of the advertisement therein is highly evaluated. Thereby, it is possible to know the effect extent when an advertisement is presented in the advertising display region.

### TECHNICAL FIELD

The present invention relates to an advertising information processing system, an advertising display region evaluation method, and an advertising information processing program, and in particular, is preferably used in a system for performing processing relevant to advertising to be displayed in a three-dimensional spatial image.

### BACKGROUND ART

Recently, a virtual reality (VR) technology that allows a virtual world created in a computer to be experienced as reality has been widely utilized. There are various application examples of VR, and one of the application examples is that a three-dimensional spatial image is displayed on a head mount display (HMD) that is mounted on a user, and thus, the user is capable of having various virtual experiences in a three-dimensional spatial image that is drawn with respect to the HMD. In such a type of VR technology, a VR technology in which a whole-sky image is seen in accordance with the motion of the visual line or the head of the user is generally provided.

In the related art, a method of presenting an advertisement by utilizing the attribute of the virtual reality is proposed (for example, refer to Patent Documents 1 and 2). In a system described in Patent Document 1, a service provider terminal receives assignment for mounting an advertising tower in a part of a space of a virtual reality space, and provides the advertising tower in the space. Then, when the advertising tower is designated in the virtual reality space by a cursor on a user terminal, more detailed information on an advertisement that is displayed on the advertising tower is provided to the user terminal.

In an advertising display device described in Patent Document 2, a service agent is positioned in a virtual space, and presents advertising data of a virtual service store to a user. On the other hand, a user agent moves in the virtual space. Then, when the user agent is in the vicinity of the service agent, the service agent starts an interaction with respect to the user, and when the user responds to the interaction, advertising data included in the service agent is displayed.
Patent Document 1: JP-A-1996-87489
Patent Document 2: JP-A-2002-109361

### DISCLOSURE OF THE INVENTION

According to the technologies described in Patent Documents 1 and 2, it is possible to present the advertisement by utilizing the attribute of the virtual reality. However, when an advertisement is presented in an advertising display region set in the three-dimensional spatial image (corresponding to a region of the advertising tower in Patent Document 1, and a region in the vicinity of the service agent in Patent Document 2), it is not known how much advertising effect is expected. For this reason, it is not necessarily possible to present an optimal advertisement that is desired by an advertising provider or an affiliator.

The invention has been made in order to solve such problems described above, and an object thereof is to enable presenting an optimal advertisement desired by the advertising provider, the affiliator, or the like such that it is possible to know an effect extent when the advertisement is presented in the advertising display region set in the three-dimensional spatial image.

In order to attain the object described above, in the invention, an object that a viewer pays attention to is detected while a three-dimensional spatial image including a plurality of objects is played back, and an attention degree of the viewer with respect to the object is calculated on the basis of a detection result. Then, a degree of effect of an advertising display region to be disposed in the vicinity of at least one object of the plurality of objects is evaluated, in accordance with the calculated attention degree.

According to the invention configured as described above, since an advertising display region to be disposed in the vicinity of an object having a high attention degree from the viewer, in the plurality of objects included in the three-dimensional spatial image, is more likely to be seen by the viewer, it is possible to highly evaluate a degree of effect of an advertisement therein. Accordingly, according to the invention, it is possible to know the effect extent when the advertisement is presented in the advertising display region set in the three-dimensional spatial image, as the degree of effect. As a result thereof, it is possible to present an optimal advertisement that is desired by the advertising provider, the affiliator, or the like, on the basis of the evaluated degree of effect.

### BRIEF DESCRIPTION OF THE DRAWINGS

FIG. 1 is a diagram illustrating an overall configuration example of an advertising information processing system according to a first embodiment.

FIG. 2 is a block diagram illustrating a functional configuration example of the advertising information processing system according to the first embodiment.

FIG. 3 is a diagram schematically illustrating a three-dimensional spatial image.

FIG. 4 is a diagram illustrating an example of detecting an object that is drawn in a predetermined region set in a central portion of a playback range, as an attention object.

FIG. 5 is a block diagram illustrating a functional configuration example of an advertising information processing system according to a second embodiment.

### MODE FOR CARRYING OUT THE INVENTION

### First Embodiment

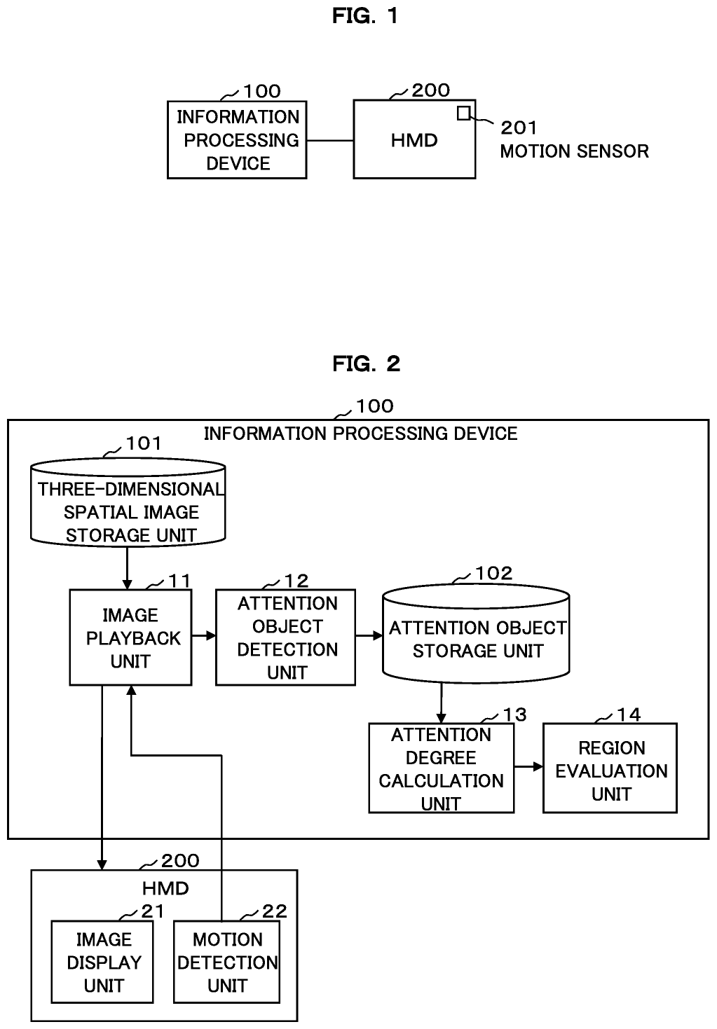

Hereinafter, a first embodiment of the invention will be described on the basis of the drawings. FIG. 1 is a diagram illustrating an overall configuration example of an advertising information processing system according to the first embodiment. As illustrated in FIG. 1, the advertising information processing system of the first embodiment includes an information processing device 100 and an HMD 200.

The information processing device 100 performs playback processing a three-dimensional spatial image in virtual reality, and performs evaluation processing an advertising display region that is included in the three-dimensional spatial image. The information processing device 100, for example, includes a personal computer or a server computer. In the HMD 200, a motion sensor 201 such as a gyro sensor or an acceleration sensor is mounted, and a head motion of a viewer can be detected. The information processing device 100 and the HMD 200 are connected to each other through a wired or wireless communication network.

FIG. 2 is a block diagram illustrating a functional configuration example of the advertising information processing system according to the first embodiment. As illustrated in FIG. 2, the information processing device 100 includes an image playback unit 11, an attention object detection unit 12, an attention degree calculation unit 13, and a region evaluation unit 14, as a functional configuration thereof. In addition, the information processing device 100 includes a three-dimensional spatial image storage unit 101 and an attention object storage unit 102, as a storage medium. On the other hand, the HMD 200 includes an image display unit 21 and a motion detection unit 22, as a functional configuration thereof.

Each of functional blocks 11 to 14 of the information processing device 100 can be implemented by any one of hardware, a digital signal processor (DSP), and software. For example, when each of the functional blocks 11 to 14 is implemented by the software, each of the functional blocks 11 to 14 actually includes a CPU, an RAM, an ROM, and the like of a computer, and is fulfilled by operating a program stored in a recording medium such as the RAM or the ROM, a hard disk, or a semiconductor memory.

Note that, here, the information processing device 100 and the HMD 200 are separately configured, but the HMD 200 may have the function of the information processing device 100. In addition, the HMD 200 may include the image playback unit 11, the attention object detection unit 12, the three-dimensional spatial image storage unit 101, and the attention object storage unit 102, and the information processing device 100 may include the attention degree calculation unit 13 and the region evaluation unit 14. Further, an analysis device (not illustrated) may be provided separately from the information processing device 100, and the analysis device may have the functions of the attention degree calculation unit 13 and the region evaluation unit 14.

The three-dimensional spatial image storage unit 101 stores image data of the three-dimensional spatial image in the virtual reality. The three-dimensional spatial image is a moving image including a plurality of objects, and an advertising display region disposed in the vicinity of at least one object of the plurality of objects. The plurality of objects is a part of the three-dimensional spatial image, and the contents thereof are not limited. The advertising display region is a region for displaying advertising information, and can be set to have an arbitrary shape and an arbitrary size.

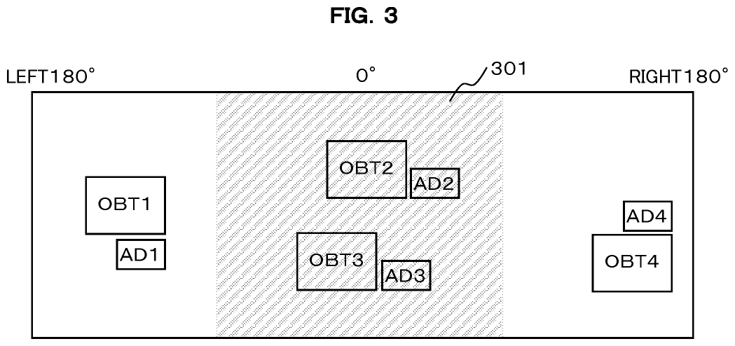

FIG. 3 is a diagram schematically illustrating the three-dimensional spatial image. Here, for the convenience of the description, one frame of the three-dimensional spatial image in which all directions of 360 degrees can be seen in accordance with the head motion of the viewer with respect to a horizontal direction is illustrated, but the three-dimensional spatial image is not limited thereto. That is, the three-dimensional spatial image may be an image in which the direction of the whole-sky can be seen in accordance with the head motion of the viewer with respect to a horizontal direction and a vertical direction.

In FIG. 3, a three-dimensional spatial image of 0 degrees to 180 degrees in a right direction and 0 degrees to 180 degrees in a left direction at an angle of a state in which the viewer with the HMD 200 is directed to a front direction (set to 0 degrees) as a center is illustrated. 180 degrees in the right direction and 180 degrees in the left direction are linked to each other. In such a three-dimensional spatial image in all directions of 360 degrees, a three-dimensional spatial image of a part of a region according to the direction to which the viewer is directed is displayed on the HMD 200. For example, when the viewer is directed to the front direction, a three-dimensional spatial image of a region 301 represented by a hatched line is displayed on the HMD 200.

In the example of FIG. 3, in one frame of the three-dimensional spatial image in all directions of 360 degrees, four objects OBT1 to OBT4 and four advertising display regions AD1 to AD4 are included. The four advertising display regions AD1 to AD4 are disposed in the vicinity of the four objects OBT1 to OBT4, respectively. The vicinity indicates being in a spontaneously visible range (for example, the range of a central visual field) even when the visual line of the viewer is not moved.

Note that, in one frame of the three-dimensional spatial image illustrated in FIG. 3, objects other than the four objects OBT1 to OBT4 are included, but the advertising display region is not set in the vicinity of the other objects. That is, FIG. 3 illustrates only the four objects OBT1 to OBT4 in which the advertising display regions AD1 to AD4 are disposed in the vicinity thereof, in the plurality of objects included in one frame of the three-dimensional spatial image.

The image playback unit 11 plays back the three-dimensional spatial image that is stored in the three-dimensional spatial image storage unit 101, and transmits image data of the three-dimensional spatial image that is played back to the HMD 200, and thus, displays the three-dimensional spatial image on the HMD 200. The image display unit 21 of the HMD 200 receives the image data of the three-dimensional spatial image that is transmitted from the image playback unit 11, and displays the three-dimensional spatial image on the HMD 200.

The motion detection unit 22 of the HMD 200 detects the head motion of the viewer, on the basis of a signal from the motion sensor 201. Then, the motion detection unit 22 transmits direction information indicating a direction to which the head of the viewer is directed to the information processing device 100. The image playback unit 11 of the information processing device 100 controls the playback of the three-dimensional spatial image from the three-dimensional spatial image storage unit 101 such that a three-dimensional space in a direction to which the viewer is directed is drawn in accordance with the head motion of the viewer indicated by the direction information that is sent from the motion detection unit 22.

That is, as illustrated in the hatched line region 301 of FIG. 3, the image playback unit 11 plays back the three-dimensional spatial image in which a front three-dimensional space is present when the viewer is directed to the front side. In addition, the image playback unit 11 plays back a three-dimensional spatial image in which a three-dimensional space according to an angle directed to the right side is present when the viewer is directed to the right side, and plays back a three-dimensional spatial image in which a three-dimensional space according to an angle directed to the left side is present when the viewer is directed to the left side. As described above, the image playback unit 11 controls the playback of the three-dimensional spatial image such that the three-dimensional space that is fulfilled on the display of the HMD 200 is dynamically changed in accordance with the head motion of the viewer.

The attention object detection unit 12 detects an object that the viewer pays attention to in the three-dimensional spatial image that is played back by the image playback unit 11 and is displayed on the HMD 200. Specifically, the attention object detection unit 12 detects an object drawn in the three-dimensional spatial image that is played back by the image playback unit 11, as the object that the viewer pays attention to (hereinafter, referred to as an attention object).

For example, when a three-dimensional spatial image of the hatched line region 301 illustrated in FIG. 3 is played back by the image playback unit 11, the attention object detection unit 12 detects two objects OBT2 and OBT3 drawn in the three-dimensional spatial image of the hatched line region 301, as the attention object. This is because the three-dimensional spatial image that is played back by the image playback unit 11 is an image of a region corresponding to a direction to which the head of the viewer is directed with intention, and thus, it is possible to assume that an object included therein may be the object that the viewer is paying attention to.

Note that, all of the objects drawn in the three-dimensional spatial image that is played back by the image playback unit 11 may be detected as the attention object, and in the objects drawn in the three-dimensional spatial image that is played back by the image playback unit 11, an object drawn in a predetermined region that is set in a central portion of a playback range may be detected as the attention object. This is because the viewer tends to particularly see the vicinity of the center of the three-dimensional spatial image that is played back by the image playback unit 11, and may not pay attention to the surrounding portion in the three-dimensional spatial image.

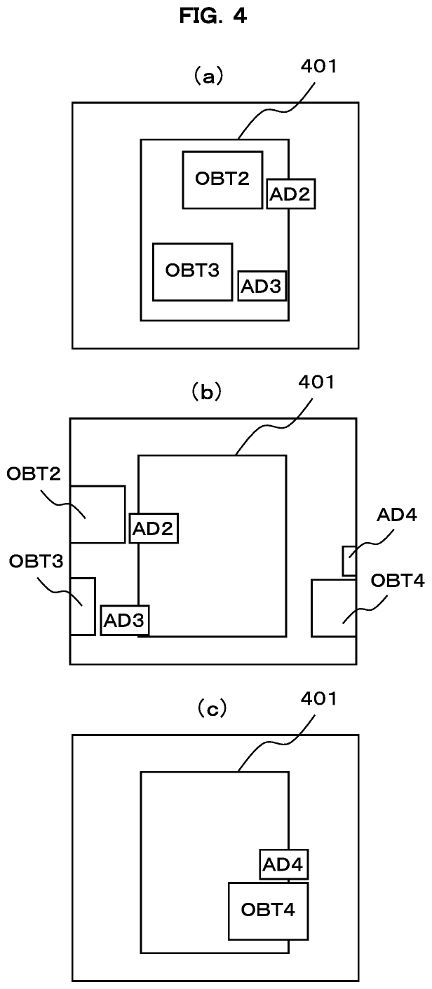

FIG. 4 is a diagram illustrating an example in which the object drawn in the predetermined region that is set in the central portion of the playback range is detected as the attention object. FIG. 4(a) illustrates a state in which the three-dimensional spatial image of the hatched line region 301 illustrated in FIG. 3 is played back by the image playback unit 11 and is displayed on a display screen of the HMD 200. In the central portion of the playback range (that is, the central portion of the three-dimensional spatial image that is played back), a detection region 401 for detecting the attention object is set. The detection region 401 can be set to have an arbitrary shape and an arbitrary size.

In the example of FIG. 4(a), two objects OBT2 and OBT3 are included in the three-dimensional spatial image that is played back by the image playback unit 11. Both of the two objects OBT2 and OBT3 are included in the detection region 401 of the central portion. Accordingly, the attention object detection unit 12 detects the two objects OBT2 and OBT3, as the attention object. Note that, the object that is detected as the attention object may be only an object of which the whole is included in the detection region 401, or may be an object of which at least a part is included in the detection region 401.

FIG. 4(b) illustrates a state in which the three-dimensional spatial image is played back by the image playback unit 11 and is displayed on the display screen of the HMD 200, in accordance with an angle in the right direction to which the viewer is directed, when the viewer is slightly directed to the right direction. In such a three-dimensional spatial image, three objects OBT2 to OBT4 are included. However, none of the objects OBT2 to OBT4 is included in the detection region 401. Accordingly, the attention object detection unit 12 does not detect the three objects OBT2 to OBT4, as the attention object.

FIG. 4(c) illustrates a state in which the three-dimensional spatial image is played back by the image playback unit 11 and is displayed on the display screen of the HMD 200, in accordance with an angle in the right direction to which the viewer is directed, when the viewer is considerably directed to the right direction. In the three-dimensional spatial image, one object OBT4 is included. A part of the object OBT4 is included in the detection region 401 of the central portion. Accordingly, the attention object detection unit 12 detects the object OBT4, as the attention object.

Note that, only when an object is continuously included in the detection region 401 for a predetermined time or longer (or the predetermined number of frames or more), the attention object detection unit 12 may detect the object, as the attention object.

The attention object storage unit 102 stores information of the attention object that is detected by the attention object detection unit 12. FIG. 4 described above illustrates one frame of the moving image, and the attention object detection unit 12 detects the attention object for each frame of the moving image. The attention object detection unit 12 stores information for identifying the detected attention object (an object ID or the like), and information such as a time of paying attention to the object, and the number of times of the attention on the object, in the attention object storage unit 102.

Here, the time of paying attention to the object is a value that is set in accordance with the number of frames of the three-dimensional spatial image that is played back in a state where the object is included in the detection region 401. In addition, the number of times of the attention on the object is the number of times of the playback of the three-dimensional spatial image in a state where the object is included in the detection region 401, and the number of times of the attention is counted as one while the object is continuously displayed in the detection region 401.

The attention object storage unit 102 stores the information of the attention object that is detected by the attention object detection unit 12 with respect to a plurality of viewers. That is, the attention object detection unit 12 detects the attention object every time when the three-dimensional spatial image is viewed by the plurality of viewers, and stores information such as identification information of the detected attention object, the an attention time and the number of times of the attention, in the attention object storage unit 102. Note that, a detection mode can be set, and only when the detection mode is set, the attention object may be detected.

The attention degree calculation unit 13 calculates an attention degree of the viewer with respect to the object, on the basis of a detection result of the attention object detection unit 12 (the information of the attention object that is stored in the attention object storage unit 102). For example, the attention degree calculation unit 13 calculates the attention degree of the viewer with respect to the object, in objects respectively detected by the attention object detection unit 12 when the plurality of viewers view the three-dimensional spatial image, on the basis of at least one of the total number of times and the total time of the attention. The calculated attention degree may be a score value, or may be a rank divided into a plurality of steps.

For example, the attention degree calculation unit 13 includes table information or a function that is set such that the attention degree increases as the total number of times of the attention increases, and calculates the attention degree of the viewer with respect to each of the objects included in the three-dimensional spatial image, on the basis of the table information or the function. Alternatively, the attention degree calculation unit 13 includes table information or a function that is set such that the attention degree increases as the total time of the attention increases, and calculates the attention degree of the viewer with respect to each of the objects included in the three-dimensional spatial image, on the basis of the table information or the function. Alternatively, the attention degree calculation unit 13 includes table information or a function that is set such that the attention degree increases as the total number of times of the attention increases and the total time of the attention increases, and calculates the attention degree of the viewer with respect to each of the objects included in the three-dimensional spatial image, on the basis of the table information or the function.

The region evaluation unit 14 evaluates a degree of effect of the advertising display region disposed in the vicinity of the object, in accordance with the attention degree that is calculated by the attention degree calculation unit 13. The degree of effect of the advertising display region is an index indicating an effect extent when the advertising information is presented in the advertising display region that is set in the three-dimensional spatial image. Here, the evaluated degree of effect may be a score value, or may be a rank. The ranks are divided into a plurality of grades. For example, the region evaluation unit 14 includes table information or a function that is set such that the degree of effect of the advertising display region disposed in the vicinity thereof increases as the attention degree of the object increases, and evaluates the degree of effect of each of the advertising display regions included in the three-dimensional spatial image, on the basis of the table information or the function.

An advertising display region that is disposed in the vicinity of an object having a high attention degree from the viewer in the plurality of objects included in the three-dimensional spatial image is more likely to be seen from the viewer. Therefore, in this embodiment, the degree of effect of the advertising display region that is set in the three-dimensional spatial image is evaluated such that the higher attention degree an object has, the higher degree of effect an advertising display region disposed in the vicinity of the object has. An evaluation result, for example, is output as a report.

The evaluation result of the degree of effect of the region evaluation unit 14 can be applied to various purposes. For example, when the advertising display region included in the three-dimensional spatial image is sold to an advertising provider, an affiliator, or the like, it is possible to set the price according to the degree of effect. Alternatively, it is possible to assign a plurality of advertising information items to be provided from the advertising provider, the affiliator, or the like to the advertising display region according to the degree of effect to be displayed. Alternatively, it is possible to edit a setting location of the advertising display region, in accordance with the degree of effect, such as the elimination of an advertising display region having a degree of effect of a certain level or less.

As described above in detail, in the first embodiment, the object that the viewer pays attention to is detected while the three-dimensional spatial image including the plurality of objects and the advertising display region disposed in the vicinity of at least one object of the plurality of objects is played back. And the attention degree of the viewer with respect to the object is calculated on the basis of the detection result. Then, the degree of effect of the advertising display region disposed in the vicinity of the object is evaluated, in accordance with the calculated attention degree.

According to the first embodiment configured as described above, it is possible to highly evaluate, in terms of the degree of effect of the advertisement, the advertising display region that is disposed in the vicinity of the object having a high attention degree from the viewer in the plurality of objects included in the three-dimensional spatial image, and to lowly evaluate, in terms of the degree of effect of the advertisement, the advertising display region that is disposed in the vicinity of an object having a lower attention degree. Accordingly, according to the first embodiment, it is possible to know the effect extent when the advertising information is presented in the advertising display region that is set in the three-dimensional spatial image.

### Second Embodiment

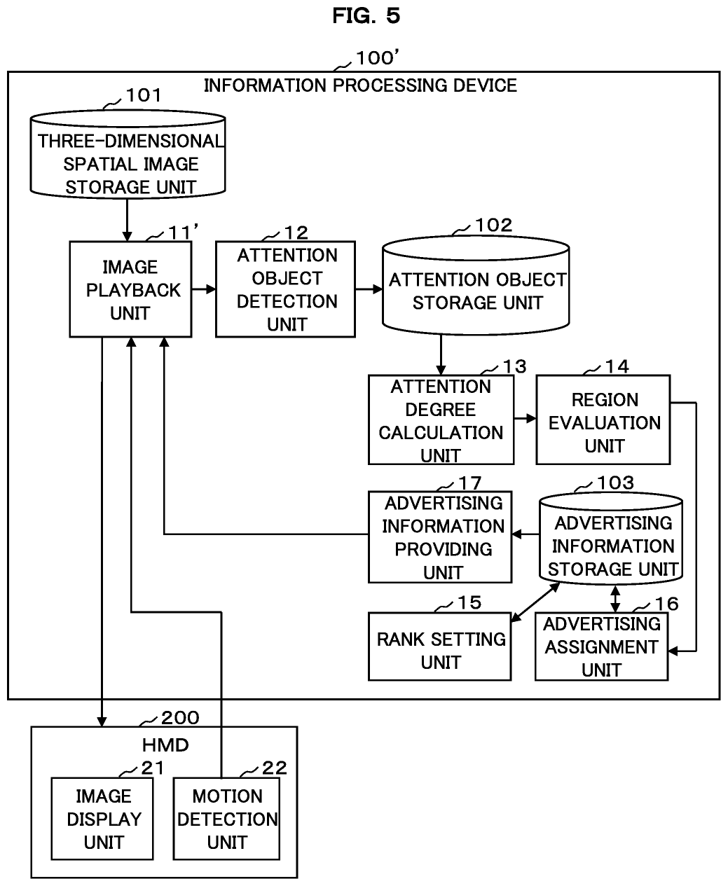

Next, a second embodiment of the invention will be described on the basis of the drawings. The overall configuration of an advertising information processing system according to the second embodiment, for example, is identical to that of FIG. 1. FIG. 5 is a block diagram illustrating a functional configuration example of the advertising information processing system according to the second embodiment. Note that, in FIG. 5, constituents to which the same reference numerals as those illustrated in FIG. 2 have the same functions, and thus, here, the repeated description will be omitted.

As illustrated in FIG. 5, an information processing device 100′ according to the second embodiment further includes a rank setting unit 15, an advertising assignment unit 16, and an advertising information providing unit 17, as a functional configuration thereof. In addition, the information processing device 100′ includes an image playback unit 11′ instead of the image playback unit 11. In addition, the information processing device 100′ according to the second embodiment further includes an advertising information storage unit 103, as a storage medium.

The advertising information storage unit 103 stores various advertising information items to be provided from the advertising provider, the affiliator, or the like. The advertising information may be still image information, or may be moving image information. The advertising information to be stored in the advertising information storage unit 103 is advertising information to be displayed in a plurality of advertising display regions that are set in the three-dimensional spatial image.

The rank setting unit 15 sets a rank with respect to the plurality of advertising information items that are stored in the advertising information storage unit 103, that is, the plurality of advertising information items to be displayed in the advertising display region in the three-dimensional spatial image. Here, a rank setting method is arbitrary. For example, when the advertising display region included in the three-dimensional spatial image is sold, a higher rank is set to advertising information that is provided from a person who purchased a more expensive advertising display region. In addition, a higher rank may be set to advertising information having a higher important degree. The rank that is set by the rank setting unit 15 is stored in the advertising information storage unit 103, in association with the advertising information.

The advertising assignment unit 16 assigns advertising information having a higher rank set by the rank setting unit 15 to an advertising display region having a higher degree of effect evaluated by the region evaluation unit 14. Information relevant to such assignment is also stored in the advertising information storage unit 103, in association with the advertising information.

The advertising information providing unit 17 provides the advertising information that is stored in the advertising information storage unit 103, in the advertising display region in the three-dimensional spatial image that is played back by the image playback unit 11′, in accordance with the assignment of the advertising assignment unit 16.

The image playback unit 11′ embeds the advertising information that is provided from the advertising information providing unit 17, in accordance with the assignment of the advertising assignment unit 16, in the advertising display region in the three-dimensional spatial image that is played back. Then, the image data of the three-dimensional spatial image in a state where the advertising information is embedded in the advertising display region is transmitted to the HMD 200. Accordingly, a three-dimensional spatial image in a state where the advertising information is embedded in the advertising display region is displayed on the display screen of the HMD 200. Note that, an advertising display button may be displayed in the advertising display region, and when the advertising display button is manipulated by the viewer, the advertising information may be displayed.

Note that, any one of a region evaluation mode and a normal playback mode can be selectively set with respect to the image playback unit 11′, and when the region evaluation mode is set, the image playback unit 11′ plays back the three-dimensional spatial image without embedding the advertising information in the advertising display region, whereas when the normal playback mode is set, the three-dimensional spatial image may be played back in a state where the advertising information is embedded in the advertising display region. Accordingly, when the region evaluation mode is set, the advertising information is not displayed, and thus, it is possible to evaluate the degree of effect of the advertising display region, genuinely according to the attention degree with respect to the object. Then, when the normal playback mode is set, it is possible to suitably provide the advertising information that is assigned in accordance with the degree of effect, in the advertising display region in the three-dimensional spatial image.

As described above in detail, according to the second embodiment, it is possible to evaluate the effect extent when the advertising information is presented in the advertising display region that is set in the three-dimensional spatial image, as the degree of effect, and to suitably provide the advertising information that is assigned in accordance with the degree of effect, in the advertising display region in the three-dimensional spatial image. Accordingly, for example, it is possible to present an optimal advertisement that is desired by the advertising provider, the affiliator, or the like, such as presenting advertising information having a high rank that is set, in the advertising display region that is highly evaluated in the degree of effect.

Note that, in the first embodiment and the second embodiment described above, an example in which the object that is drawn in the three-dimensional spatial image played back in accordance with the head motion of the viewer that is detected by the motion sensor 201 of the HMD 200 is detected as the attention object has been described, but the invention is not limited thereto. For example, a visual line sensor detecting the visual line of the viewer is mounted on the HMD 200, in addition to the motion sensor 201 detecting the head motion of the viewer. Then, the attention object detection unit 12 may detect an object in the direction of the visual line of the viewer that is detected by the visual line sensor, in the objects drawn in the three-dimensional spatial image that is played back by the image playback unit 11 (11′), as the attention object.

In the embodiments described above, an example in which the three-dimensional spatial image in which the advertising display region is set in advance in the vicinity of the object is played back, and the degree of effect of the advertising display region is evaluated in accordance with the attention degree of the object has been described, but the invention is not limited thereto. For example, the three-dimensional spatial image in which the advertising display region is not set with respect to the object yet may be played back, the attention degree of the object may be calculated, and the degree of effect of the advertising display region when it is assumed that the advertising display region is set in a location in the vicinity of the object may be evaluated. In this case, it is possible to actually set the advertising display region in a location that is highly evaluated in terms of the degree of effect.

In the first embodiment and the second embodiment described above, an example in which the three-dimensional spatial image in the virtual reality is played back, and the advertising display region is set in the three-dimensional spatial image has been described, but the invention is not limited thereto. For example, a three-dimensional spatial image in augmented reality may be played back, and the advertising display region may be set in the three-dimensional spatial image.

In addition, both of the first embodiment and the second embodiment described above are merely a specified example in carrying out the invention, and the technical scope of the invention is not limited thereto. That is, the invention can be carried out in various forms without departing from the gist or main characteristics thereof.

### REFERENCE SIGNS LIST

11, 11′ Image playback unit
12 Attention object detection unit
13 Attention degree calculation unit
14 Region evaluation unit
15 Rank setting unit
16 Advertising assignment unit
17 Advertising information providing unit
21 Image display unit
22 Motion detection unit
100, 100′ Information processing device
200 HMD

1. An advertising information processing system, characterized by comprising:
an image playback unit playing back a three-dimensional spatial image including a plurality of objects to be displayed on a display;
an attention object detection unit detecting an object that a viewer pays attention to in the three-dimensional image displayed by the image playback unit;
an attention degree calculation unit calculating an attention degree of the viewer with respect to the object, on the basis of a detection result of the attention object detection unit; and
a region evaluation unit evaluating a degree of effect of an advertising display region that is disposed in the vicinity of at least one object of the plurality of objects, in accordance with the attention degree calculated by the attention degree calculation unit.

2. The advertising information processing system according to claim 1, characterized by further comprising:
a rank setting unit setting a rank with respect to a plurality of advertising information items to be displayed in the advertising display region; and
an advertising assignment unit assigning advertising information having the higher rank set by the rank setting unit to an advertising display region, the higher degree of effect evaluated by the region evaluation unit the advertising display region has.

3. The advertising information processing system according to claim 2, characterized by further comprising:
an advertising information providing unit providing the advertising information to the advertising display region, in accordance with the assignment performed by the advertising assignment unit.

4. The advertising information processing system according to claim 1, characterized in that the three-dimensional spatial image is a three-dimensional spatial image in virtual reality,
the display is a head mount display on which a motion sensor detecting a head motion of the viewer is mounted,
the image playback unit controls the playback of the three-dimensional spatial image such that a three-dimensional space in a direction to which the viewer is directed is drawn, in accordance with the head motion of the viewer that is detected by the motion sensor, and
the attention object detection unit detects an object drawn in the three-dimensional spatial image that is played back by the image playback unit, as the object that the viewer pays attention to.

5. The advertising information processing system according to claim 4, characterized in that the attention object detection unit detects an object drawn in a predetermined region that is set in a central portion of a playback range, in the objects drawn in the three-dimensional spatial image that is played back by the image playback unit, as the object that the viewer pays attention to.

6. The advertising information processing system according to claim 4, characterized in that the display is a head mount display on which a visual line sensor detecting a visual line of the viewer is mounted, in addition to the motion sensor detecting the head motion of the viewer, and
the attention object detection unit detects an object in a direction of the visual line of the viewer that is detected by the visual line sensor, in the objects drawn in the three-dimensional spatial image that is played back by the image playback unit, as the object that the viewer pays attention to.

7. The advertising information processing system according to claim 1, characterized in that the attention degree calculation unit calculates the attention degree of the viewer with respect to the object, in objects respectively detected by the attention object detection unit when a plurality of viewers view the three-dimensional spatial image, on the basis of at least one of the total number of times and a total time of the attention.

8. A method for evaluating an advertising effect of an advertising display region that is disposed in the vicinity of at least one object of a plurality of objects, in a computer system in which a three-dimensional spatial image including the plurality of objects is played back and is displayed on a display, the method characterized by comprising:
a first step of allowing an attention object detection unit of the computer system to detect an object that a viewer pays attention to in the three-dimensional image displayed on the display;
a second step of allowing an attention degree calculation unit of the computer system to calculate an attention degree of the viewer with respect to the object, on the basis of a detection result of the attention object detection unit; and
a third step of allowing a region evaluation unit of the computer system to evaluate a degree of effect of the advertising display region, in accordance with the attention degree calculated by the attention degree calculation unit.

9. A computer-readable advertising information processing program for executing processing relevant to an advertisement with respect to a computer system in which a three-dimensional spatial image including a plurality of objects, and advertising information embedded in an advertising display region disposed in the vicinity of at least one object of the plurality of objects is played back and is displayed on a display, the advertising information processing program for allowing a computer to function as:
attention object detection means detecting an object that a viewer pays attention to in the three-dimensional image displayed on the display;
attention degree calculation means calculating an attention degree of the viewer with respect to the object, on the basis of a detection result of the attention object detection means; and
region evaluation means evaluating a degree of effect of the advertising display region that is disposed in the vicinity of the object, in accordance with the attention degree calculated by the attention degree calculation means.

10. The computer-readable advertising information processing program according to claim 9, for allowing the computer to further function as:
rank setting means setting a rank with respect to a plurality of advertising information items to be displayed in the advertising display region; and
advertising assignment means assigning advertising information having the higher rank set by the rank setting means to an advertising display region, the higher degree of effect evaluated by the region evaluation means the advertising display region has.

11. The advertising information processing system according to any one of claim 2, characterized in that the three-dimensional spatial image is a three-dimensional spatial image in virtual reality,
the display is a head mount display on which a motion sensor detecting a head motion of the viewer is mounted,
the image playback unit controls the playback of the three-dimensional spatial image such that a three-dimensional space in a direction to which the viewer is directed is drawn, in accordance with the head motion of the viewer that is detected by the motion sensor, and
the attention object detection unit detects an object drawn in the three-dimensional spatial image that is played back by the image playback unit, as the object that the viewer pays attention to.

12. The advertising information processing system according to any one of claim 3, characterized in that the three-dimensional spatial image is a three-dimensional spatial image in virtual reality,
the display is a head mount display on which a motion sensor detecting a head motion of the viewer is mounted,
the image playback unit controls the playback of the three-dimensional spatial image such that a three-dimensional space in a direction to which the viewer is directed is drawn, in accordance with the head motion of the viewer that is detected by the motion sensor, and
the attention object detection unit detects an object drawn in the three-dimensional spatial image that is played back by the image playback unit, as the object that the viewer pays attention to.
